(19) United States
(12) Patent Application Publication
(10) Pub. No.: US 2005/0037728 A1
(43) Pub. Date: Feb. 17, 2005

(54) Emergency broadcast message in a wireless communication device

(76) Inventors: Charles P. Binzel, Bristol, WI (US); Marcia J. Otting, Mundelein, IL (US)

Correspondence Address: MOTOROLA INC, 600 NORTH US HIGHWAY 45, ROOM AS437, LIBERTYVILLE, IL, 60048-5343, US

(21) Appl. No.: 10/639,899

(22) Filed: Aug. 13, 2003

(51) Int. Cl. H04M 11/04

(52) U.S. Cl. 455/404.1; 455/412.1

(57) ABSTRACT

A method (200, 400) and an apparatus (500) in a wireless communication system for communicating contents of a broadcast message are provided. A wireless portable communication device (104) receives an emergency status indicator associated with the broadcast message from a base station (102). Upon determining the broadcast message is an emergency message, the contents of the broadcast message are immediately communicated.

### FIELD OF THE INVENTION

The present invention generally relates to broadcasting, and more specifically to broadcasting a message in an emergency situation to a targeted audience.

### BACKGROUND OF THE INVENTION

In a wireless communication system, such as a cellular telephone system, the system can broadcast messages from a base station to wireless portable communication devices, or mobile terminals, registered to the base station by the short message service (“SMS”), or by cell broadcast service (“CBS”). Generally, a user subscribes to a service provider for messages that provide information of his choice, such as news, sports, stock quotes, and others alike, and receives messages containing information of his choice from the service provider. However, there is no requirement to subscribe to any broadcast message service, and those mobile terminals without subscription may ignore all broadcast messages. The base station broadcasts CBS messages cyclically, including messages already broadcast, and the mobile terminal receiving the CBS messages identifies and ignores such messages. The mobile terminal is also capable of identifying and ignoring undesired messages such as unsolicited advertisements.

When the CBS messages are received, the mobile terminal allows the user to select and display the received messages later, which is convenient for the user who wishes to view the messages but does not wish to view the received message immediately. However, this capability of allowing the user to delay displaying the received message may be detrimental to the user's interest in some circumstances. Further, those users without any message subscription may not even be aware of CBS messages. In emergency or time critical situations, such as a traffic accident, traffic jam, severe weather, fire, or crime, it would be in the user's and the public's best interest to receive and view a message regarding the emergency as soon as the message is broadcast. For example, if a severe weather condition, such as a tornado, has just developed in the area where the user is located and a local base station broadcasts a message notifying of the tornado in the area, it would be in the user's best interest to receive and view the message as soon as it is broadcast. In other situations such as in a case of a missing person or kidnapping, it is desirable, or may be critical, to notify as soon as possible people in a relevant area such as a city where the missing or kidnapped person was last seen. Under emergency or time critical situations such as those described above, it is desirable to be able to communicate a message to the user at the mobile terminal as soon as the network broadcasts the message.

### BRIEF DESCRIPTION OF THE DRAWINGS

FIG. 1 is an exemplary block diagram of an environment where the present invention may be practiced;

FIG. 2 is an exemplary flowchart of a first preferred embodiment in accordance with the present invention;

FIG. 3 is an exemplary flowchart further illustrating one of the blocks of FIG. 2;

FIG. 4 is an exemplary flowchart of a corresponding method relative to the formation and communication of an emergency message in a wireless communication system; and

FIG. 5 is an exemplary block diagram of an apparatus for the wireless portable communication device.

### DETAILED DESCRIPTION OF THE PREFERRED EMBODIMENTS

During an emergency situation, it is desirable, and often critical, to be able to send a message to people who may be directly affected by the emergency situation, notifying them immediately about the nature of the emergency rather than just notifying that there is an emergency. A wireless portable communication device, such as a cellular telephone, capable of receiving broadcast messages from a base station, is now available. A user of such cellular telephone can subscribe to a service to receive broadcast messages of his interest such as stock quotes, sports, weather, and others alike. However, with this type of broadcast message service, the cellular telephone can be set to save the broadcast message received to be accessed at a later time, or be set to ignore all incoming broadcast messages. This capability, while being convenient to the user, is a hindrance for an emergency message, which needs to be communicated upon receipt. The present invention provides a method and apparatus for communicating an emergency message upon broadcast in a wireless communication system.

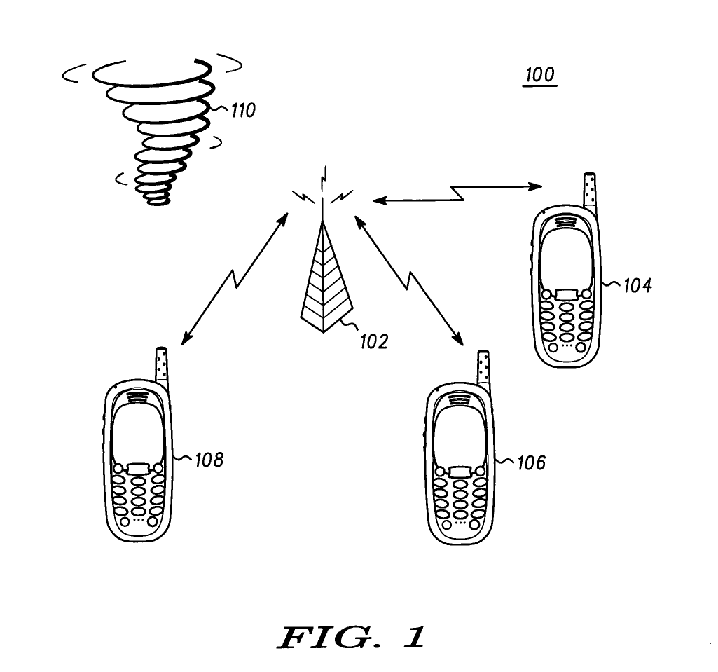

FIG. 1 is an exemplary block diagram 100 of an environment where the present invention may be practiced. In this environment, there are a base station 102, which is connected to a wireless communication network (not shown), a plurality of wireless portable communication devices, of which three devices 104, 106, and 108 are shown, and an emergency situation 110 depicting a tornado in the area. The wireless portable communication devices 104, 106, and 108 are registered to the wireless communication network by way of the base station 102, and are capable of receiving broadcast messages transmitted from the base station 102.

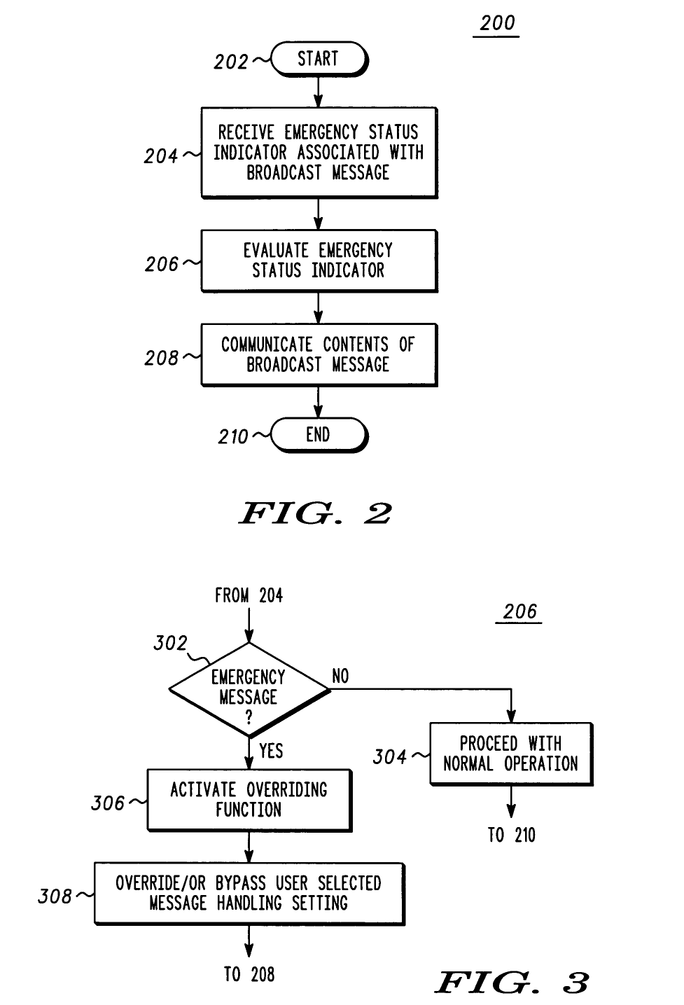

FIG. 2 is an exemplary flowchart 200 of a first preferred embodiment in accordance with the present invention. The wireless portable communication device 104, which is one of the plurality of wireless portable communication devices illustrated in FIG. 1, is used as an exemplary wireless portable communication device to describe the process illustrated in the exemplary flowchart 200. The process in the wireless portable communication device 104 begins in block 202. In block 204, the wireless portable communication device 104 receives an emergency status indicator associated with a broadcast message. The broadcast message may also be received when the emergency status indicator is received. The wireless portable communication device 104 then evaluates the emergency status indicator associated with the broadcast message in block 206. The emergency status indicator may be any one of, or any combination of, the following parameters to indicate whether the broadcast message is an emergency message, such as but not limited to: an emergency bit predetermined in a paging header; an emergency bit predetermined in a periodic overhead message; a predetermined bit in a broadcast message; a predetermined emergency paging message in a paging block; a global reserved mobile identity such as a reserved temporary mobile subscriber identity (“TMSI”) and any other appropriate and/or available parameters. The wireless portable communication device 104, then in block 208, communicates the contents of the broadcast message, and the process terminates in block 210.

FIG. 3 is an exemplary flowchart further illustrating block 206 of FIG. 2. In block 302, the wireless portable communication device 104 determines whether the broadcast message is an emergency message based on the emergency status indicator associated with the broadcast message. If the emergency status indicator associated with the broadcast message indicates that the broadcast message is not an emergency message in block 302, then the wireless portable communication device 104 proceeds with its normal operation in block 304, and the process terminates in block 210. However, if the emergency status indicator associated with the broadcast message does indicate that the broadcast message is an emergency message in block 302, then the wireless portable communication device 104 activates an overriding function in block 306. As illustrated before, the wireless portable communication device 104 can be set to delay communicating the contents of, or dismiss, the broadcast message by having a user selected message handling setting in the wireless portable communication device 104 appropriately configured. The overriding function is designed to override or bypass any conflicting user selected message handling setting such that the broadcast message is received, and the contents of the broadcast message are communicated without delay. In block 308, the wireless portable communication device 104 overrides the user selected message handling setting, which had previously allowed delayed communication of the contents, or dismissal of, the broadcast message. Then the process advances to block 208 where the wireless portable communication device 104 communicates the contents of the broadcast message without delay.

The wireless portable communication device 104 may access the contents of the broadcast message in several ways. For example, in a wireless communication system in which the emergency status indicator is broadcast in a different channel from the channel used for the broadcast message (“broadcast message channel”), the wireless portable communication device 104 may be directed to switch to the broadcast message channel upon overriding the user selected message handling setting. The wireless portable communication device 104 then receives the broadcast message, and communicates the contents of the broadcast message.

The wireless portable communication device 104 may communicate the contents of the broadcast message in a variety of ways. For example, the contents may be displayed as a text message on a display of the wireless portable communication device 104. The wireless portable communication device 104 may also communicate the contents of the broadcast message by audibly playing the contents. The contents of the broadcast message may include a variety of information, including the nature of the emergency such as a traffic accident and a severe weather condition, a contact or reply phone number at which notified users may call and obtain or provide further information, a relevant picture associated with the emergency such as a map showing where the accident scene is, a picture of a missing person, a universal resource locator (“URL”) directing the user to a site with more information, or any other relevant information that may be helpful to the notified users. The wireless portable communication device 104 may be automatically directed to a relevant web site with more information upon determination of the broadcast message as an emergency message.

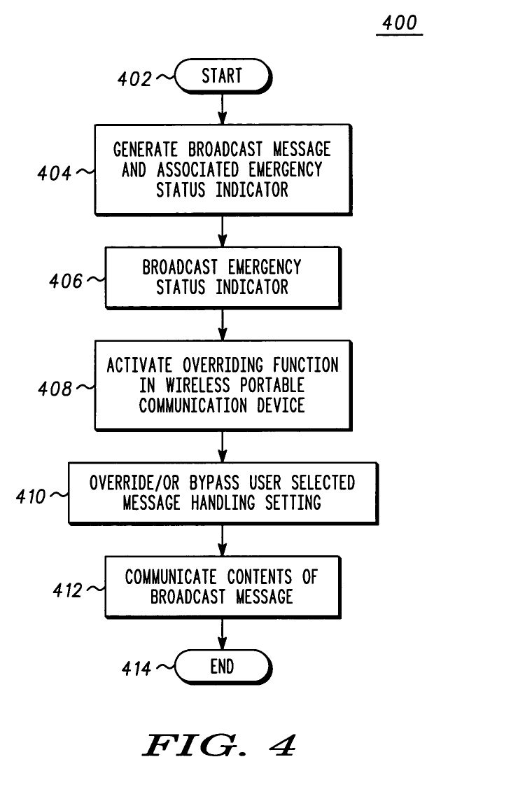

FIG. 4 is an exemplary flowchart 400 of a corresponding method relative to the formation and communication of an emergency message in a wireless communication system. The wireless portable communication device 104, which is one of the plurality of wireless portable communication devices illustrated in FIG. 1, is used as an exemplary wireless portable communication device to describe the process illustrated in the exemplary flowchart 400. The process in the wireless communication system begins in block 402. In block 404, the wireless communication system generates a broadcast message and an emergency status indicator associated with the broadcast message, which is indicative of the broadcast message being an emergency message. The emergency status indicator may be any one of, or any combination of, the following parameters to indicate whether the broadcast message is an emergency message, such as but not limited to: an emergency bit predetermined in a paging header; an emergency bit predetermined in a periodic overhead message; a predetermined bit in a broadcast message; a predetermined emergency paging message in a paging block; a global reserved mobile identity such as a reserved temporary mobile subscriber identity (“TMSI”) and any other appropriate and/or available parameters. The base station 102 in the wireless communication system broadcasts the emergency status indicator in block 406, and the plurality of wireless portable communication devices currently registered to the wireless communication system, such as the wireless portable communication device 104, receives the emergency status indicator. The broadcast message may also be broadcast when the emergency status indicator is broadcast. Upon receipt of the emergency status indicator indicative of the associated broadcast message being an emergency message, an overriding function in the wireless portable communication device 104 is activated in block 408. As illustrated before, the wireless portable communication device 104 can be set to delay communicating the contents of, or dismiss, the broadcast message by having a user selected message handling setting in the wireless portable communication device 104 appropriately configured. The overriding function is designed to override or bypass the user selected message handling setting such that the broadcast message is received, and the contents of the broadcast message are communicated without delay. In block 410, the user selected message handling setting in the wireless portable communication device 104, which had previously allowed delayed of communication of the contents of, or dismissal of, the broadcast message, is overridden. The wireless portable communication device 104 then communicates the contents of the broadcast message without delay in block 412, and the process terminates in block 414.

To target users who are most likely affected by the emergency being communicated, the wireless communication system selects one or more base stations to broadcast the emergency status indicator based upon proximity to a geographical area associated with the contents of the broadcast message. For example, if the contents of the broadcast message pertain to a highway closure due to an accident, then the message may be broadcast from the base station serving the cell covering the accident site and from a few base stations serving cells immediately surrounding the accident site. For the contents of the broadcast message warning of a severe weather condition such as a tornado having been spotted, the message may be broadcast from several base stations enough to cover an entire county in which the tornado has been spotted.

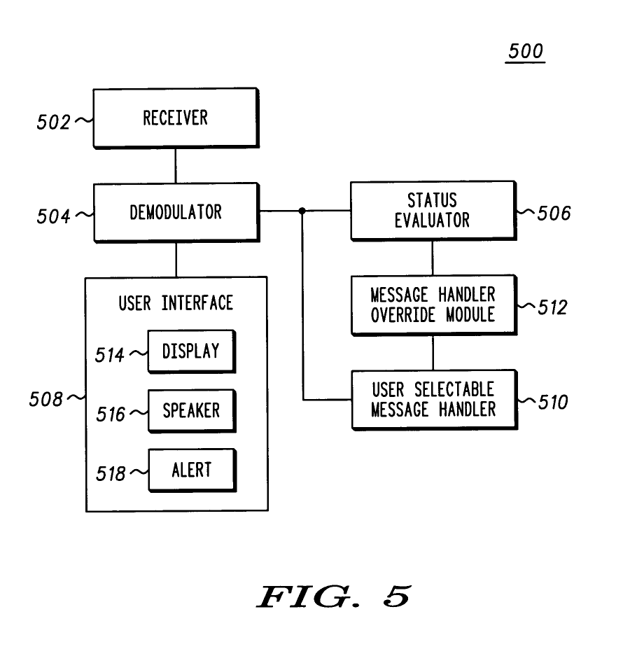

FIG. 5 is an exemplary block diagram 500 of an apparatus for the wireless portable communication device 104. The wireless portable communication device 104 comprises a receiver 502, which is configured to receive an emergency status indicator associated with a broadcast message. The emergency status indicator may be any one of, or any combination of, the following parameters to indicate whether the broadcast message is an emergency message, such as but not limited to: an emergency bit predetermined in a paging header; an emergency bit predetermined in the broadcast message; a predetermined emergency paging message in a paging block; a global reserved mobile identity; a reserved temporary mobile subscriber identity (“TMSI”); and any other appropriate and/or available parameters. A demodulator 504 is coupled to the receiver 502, and is configured to demodulate the emergency status indicator and the contents of the broadcast message. The wireless portable communication device 104 further comprises a status evaluator 506, which is coupled to the demodulator 504, and is configured to determine whether the broadcast message is an emergency message based upon the demodulated emergency status indicator from the demodulator 504. A user interface 508 is coupled to the demodulator 504, and is configured to communicate the contents of the broadcast message when the status evaluator 506 determines that the broadcast message is an emergency message based upon the demodulated emergency status indicator. The wireless portable communication device 104 further comprises a user selectable message handler 510 coupled to the demodulator 504 and a message handler override module 512 coupled to the status evaluator 506 and the user selectable message handler 510.

The user selectable message handler 510 is configured to accept a user selection, which may conflict with immediate communication of the contents of the broadcast message. For example, the user selectable message handler allows a user to configure the wireless portable communication device 104 to delay communicating the contents of, or dismiss, the broadcast message. The message handler override module 512 is configured to override or bypass the user selection. The user selection may prevent receiving the broadcast message, or immediate communication of the contents of the broadcast message. The message handler override module 512 enables immediate communication of the contents of the broadcast message by the user interface upon the determination of the broadcast message as an emergency message by the status evaluator 506.

The user interface 508, which is configured to communicate the contents of the broadcast message, may be one of a variety of interfaces. For example, the user interface may be a display 514 configured to display the contents of the broadcast message, a speaker 516 configured to audibly play the contents of the broadcast message, and an alert 518 configured to audibly play a predetermined sound specific to the broadcast message as an emergency message. The contents of the broadcast message being communicated may include a variety of information, including the nature of the emergency such as a traffic accident and a severe weather condition, a contact or reply phone number at which notified users may call and obtain or provide further information, a relevant picture associated with the emergency such as a map showing where the accident scene is, a picture of a missing person, a universal resource locator (“URL”) directing the user to a site with more information, or any other relevant information that may be helpful to the notified users.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A method in a wireless communication device for communicating contents of a broadcast message, the method comprising:
receiving an emergency status indicator associated with the broadcast message;
determining whether the emergency status indicator indicates the broadcast message is an emergency message; and
immediately communicating the contents of the broadcast message.

2. The method of claim 1, further comprising:
receiving the broadcast message when receiving the emergency status indicator.

3. The method of claim 1, further comprising after determining the broadcast message is an emergency message:
switching to an appropriate broadcast channel; and
receiving the broadcast message.

4. The method of claim 1, wherein the emergency status indicator is at least one of:
an emergency bit predetermined in a paging header;
an emergency bit predetermined in a periodic overhead message;
an emergency bit predetermined in the broadcast message;
a predetermined emergency paging message in a paging block;
a global reserved mobile identity; and
a reserved temporary mobile subscriber identity.

5. The method of claim 1, further comprising:
activating an overriding function upon determining the broadcast message is an emergency message.

6. The method of claim 5, further comprising:
overriding a user selected message handling setting of the wireless portable communication device in conflict with the immediate communication of the contents of the broadcast message, wherein the conflicting user selected message handling setting allows at least one of delayed communication of the contents of the broadcast message and dismissal of the broadcast message.

7. The method of claim 5, further comprising:
bypassing a user selected message handling setting of the wireless portable communication device in conflict with the immediate communication of the contents of the broadcast message, wherein the conflicting user selected message handling setting allows at least one of delayed communication of the contents of the broadcast message and dismissal of the broadcast message.

8. The method of claim 1, wherein immediately communicating the contents of the broadcast message by at least one of:
textually displaying the contents of the broadcast message;
graphically displaying the contents of the broadcast message; and
audibly playing the contents of the broadcast message.

9. The method of claim 8, wherein the contents of the broadcast message further include at least one of:
reply information;
a picture pertaining to at least part of the contents; and
a universal resource locator linking to a site providing further information pertaining to at least part of the contents.

10. The method of claim 1, wherein immediately communicating the contents of the broadcast message by:
activating a web browser;
directing to the web browser to a web site providing further information pertaining to at least part of the contents; and
displaying the web site.

11. A method in a wireless communication system for communicating contents of a broadcast message to a plurality of users associated with a corresponding plurality of wireless portable communication devices that are currently registered to the wireless communication system through a base station, the method comprising:
generating a broadcast message, the broadcast message associated with an emergency status indicator;
broadcasting the emergency status indicator from the base station;
upon receipt by any of the plurality of wireless portable communication devices, activating an overriding function in the wireless portable communication device;
overriding a user selected message handling setting in the wireless portable communication device; and
immediately communicating the contents of the broadcast message.

12. The method of claim 11, further comprising:
broadcasting the broadcast message when broadcasting the emergency status indicator.

13. The method of claim 11, wherein the base station broadcasting the emergency status indicator is selected based upon proximity to a geographical area associated with the contents of the broadcast message.

14. The method of claim 11, wherein the emergency status indicator is at least one of:
an emergency bit predetermined in a paging header;
an emergency bit predetermined in a periodic overhead message;
an emergency bit predetermined in the broadcast message;
a predetermined emergency paging message in a paging block;
a global reserved mobile identity; and
a reserved temporary mobile subscriber identity.

15. The method of claim 11, wherein activating the overriding function in the wireless portable communication device is based upon the emergency status indicator indicative of the broadcast message as an emergency message.

16. The method of claim 11, wherein the user selected message handling setting in the wireless portable communication device is in conflict with immediate communication of the contents of the broadcast message.

17. The method of claim 16, wherein overriding the user selected message handling setting by bypassing the user selected message handling setting.

18. The method of claim 11, after overriding the user selected message handling setting, further comprising:
switching to an appropriate broadcast channel in the wireless portable communication device; and
receiving the broadcast message at the wireless portable communication device.

19. The method of claim 11, wherein immediately communicating the contents of the broadcast message, at the wireless portable communication device, by at least one of:
textually displaying the contents of the broadcast message;
graphically displaying the contents of the broadcast message; and
audibly playing the contents of the broadcast message.

20. The method of claim 19, wherein the contents of the broadcast message further include at least one of:
reply information;
a picture pertaining to at least part of the contents; and
a universal resource locator linking to a site providing further information pertaining to at least part of the contents.

21. The method of claim 11, wherein immediately communicating the contents of the broadcast message by, at the wireless portable communication device:
activating a web browser;
directing to the web browser to a web site providing further information pertaining to at least part of the contents; and
displaying the web site.

22. A wireless portable communication device configured to communicate contents of a broadcast message, the wireless portable communication device comprising:
a receiver configured to receive an emergency status indicator associated with the broadcast message;
a demodulator coupled to the receiver, the demodulator configured to demodulate the emergency status indicator and the contents of the broadcast message;
a status evaluator coupled to the demodulator, the status evaluator configured to determine whether the broadcast message is an emergency message based upon the demodulated emergency status indicator; and
a user interface coupled to the demodulator; the user interface configured to communicate the contents of the broadcast message,
wherein the user interface communicates the contents of the broadcast message immediately upon the determination of the broadcast message as an emergency message.

23. The wireless portable communication device of claim 22, further comprising:
a user selectable message handler coupled to the demodulator, the user selectable message handler configured to accept a user selection in conflict with immediate communication of the contents of the broadcast message; and
a message handler override module coupled to the user selectable message handler and to the status evaluator; the message handler override module configured to override the user selection upon the determination of the broadcast message as an emergency message.

24. The wireless portable communication device of claim 22, wherein the user interface configured to communicate the contents of the broadcast message is at least one of:
a display configured to display textual and graphical contents of the broadcast message;
a speaker configured to audibly play the contents of the broadcast message; and
an alert configured to audibly play a predetermined sound, the predetermined sound specific to the broadcast message as an emergency message.

25. The wireless portable communication device of claim 22, wherein the emergency status indicator is at least one of:
an emergency bit predetermined in a paging header;
an emergency bit predetermined in a periodic overhead message;
an emergency bit predetermined in the broadcast message;
a predetermined emergency paging message in a paging block;
a global reserved mobile identity; and
a reserved temporary mobile subscriber identity.

26. The wireless portable communication device of claim 22, wherein the contents of the broadcast message further include at least one of:
reply information;
a picture pertaining to at least part of the contents; and
a universal resource locator linking to a site providing further information pertaining to at least part of the contents.

27. The wireless portable communication device of claim 24, wherein the user interface communicates the contents of the broadcast message immediately upon the determination of the broadcast message as an emergency message by:
activating a web browser;
directing to the web browser to a web site providing further information pertaining to at least part of the contents; and
displaying the web site on the display.
